(19) United States
(12) Patent Application Publication
(10) Pub. No.: US 2003/0210419 A1
(43) Pub. Date: Nov. 13, 2003

(54) System and methods for printing copy-protected documents

(76) Inventors: Curtis Reese, Boise, ID (US); Mark M. Josephsen, Boise, ID (US)

Correspondence Address: HEWLETT-PACKARD COMPANY, Intellectual Property Administration, P. O. Box 272400, Fort Collins, CO, 80527-2400, US

(21) Appl. No.: 10/141,571

(22) Filed: May 8, 2002

(51) Int. Cl. G06F 15/00; G06K 9/00; G06K 1/00

(52) U.S. Cl. 358/1.14; 382/112

(57) ABSTRACT

The system and methods described herein relate to printing photocopy-protected documents. Rather than requiring pre-prepared, copy-protected media for printing a copy-protected document, a copy-protection template includes background and foreground patterns that create substantially hidden copy-protection symbols on an originally printed document. A photocopy of the original document reveals the copy-protection symbols that were not noticeable in the original document. Thus, print jobs are copy-protected when they are printed on a page along with the copy-protection template.

### TECHNICAL FIELD

The present disclosure relates to invisible photocopy fraud protection, and more particularly, to printing photocopy-protected documents.

### BACKGROUND

Photocopy fraud protection is an important issue for many companies and government agencies. Putting sensitive information into printed form often requires the use of pre-prepared, copy-protected documents as a print medium. Pre-prepared, copy-protected documents can be purchased and used as the print medium in conventional printing devices. Thus, a company or agency can print sensitive information as an original or master document that has photocopy protection. By virtue of the copy-protected print medium, a photocopy of a master document typically reveals some type of security warning indicating that the copy is not an original document.

Copy-protected media, such as paper, generally has a fine printed pattern that makes up a light “gray” background on the paper. This background is typically formed by a pattern of dots, lines, screen structures or the like. Within the background pattern, additional information can be printed that is mostly hidden by the background pattern when viewed by a casual observer. The additional information typically includes a security warning such as the word “VOID” or “COPY” that is made up of a second or “foreground” pattern interspersed within the background pattern. The manner in which the second/foreground pattern is arranged within the background pattern tends to obscure the security warning. Therefore, the background pattern and security warning (i.e., foreground pattern) on the copy-protected paper are barely noticeable when viewing an original document containing typical text and/or graphical content. However, when an original copy-protected document is copied on a photocopier, the security warning becomes prominent on the copy such that even a casual observer will notice it. Thus, the original document is easily distinguishable from its copied version by virtue of a warning such as “VOID” or “COPY” being prominently displayed on the copied version.

Copy-protected paper such as described above is generally successful in satisfying the security needs of most users. However, there are significant disadvantages related to both the production and use of copy-protected paper. Disadvantages related to the use of such copy-protected paper include added costs associated with purchasing and storing the paper. Copy-protected paper is considerably more expensive than other types of print media, and in order to prevent the unauthorized production of master copy-protected documents, the paper must be stored in a secure location. An additional disadvantage is that use of this paper is labor-intensive. Each use of the copy-protected paper requires that a printer be specially loaded with the paper and then unloaded when printing on the special paper is completed.

Disadvantages related to the production of copy-protected paper involve the complex and time-intensive methods previously used in printing background and foreground patterns on the paper. In general, these methods include the use of a customized dither matrix to bypass a printer's embedded dither matrix, followed by a “pixel-by-pixel” creation of patterns printed over an entire copy-protected page. These complex and time-intensive processes contribute to the considerable cost of purchasing copy-protected paper.

Dither matrices, such as the example dither matrix of FIG. 1, are designed to optimize gray scale and color scale results for images printed on a particular printer's print engine. Different print engines have different printing process characteristics that are accounted for using a dither matrix. A particular shade of gray called for by a given printable document, for instance, may generate different charging or toner-deposition results in one print engine than it does in another. Thus, a print job asking for a 20% gray scale document might produce a 15% gray scale document in a first printer and a 25% gray scale document in a second printer. Dither matrices compensate for these print engine variations by optimally characterizing each printer's print engine and adjusting printed images accordingly. Therefore, shades of color or gray have the same look and intensity for a given document regardless of the printer model and engine used to print the document.

A dither matrix generally represents an area or cell on a printed page that is divided into regions. The matrix is populated with an ordered set of threshold values (see FIG. 1). The threshold values are used to scale the intensity range of an input image by determining whether or not pixels associated with a given matrix threshold value will be printed. The example dither matrix of FIG. 1 has 16 gray scale values. FIG. 2 provides examples of particular pixels in the matrix that will be printed if a document asks for 60% and 20% gray scale intensities for the whole page, or a sub-region of the page. For the 60% intensity matrix, pixels landing in regions whose threshold values are at or below 60% of 16 (i.e., 9.6) are printed, while pixels landing in regions whose threshold values are above 9.6 are not printed. For the 20% intensity matrix, pixels landing in regions whose threshold values are at or below 20% of 16 (i.e., 3.2) are printed, while pixels landing in regions whose threshold values are above 3.2 are not printed. Thus, a printer's dither matrix optimizes the input image for the printer's engine.

As mentioned above, prior methods of creating copy-protected pages often begin with bypassing a printer's standard dither matrix in favor of a customized dither matrix. A redefined or customized dither matrix provides the maximum amount of control over which pixels will be printed on a copy-protected page. Using a customized matrix first involves a complex design process necessary to determine threshold values for the customized matrix. The customized matrix (i.e., the threshold values) is then loaded onto a particular printer and configured to operate as called on to create copy-protected pages.

Once the customized dither matrix is loaded onto a printer, pixel data, often called “raster data”, is sent to the printer in a “pixel-by-pixel” manner to create patterns on the copy-protected page. As discussed above, a background pattern typically covers the page while a foreground pattern contains some type of security warning hidden within the background pattern.

The brief description of this prior method of producing copy-protected pages points to the method's significant disadvantages. For example, costs associated with developing a customized dither matrix can be considerable. Furthermore, although some methods “pre-dither” the “raster data” with the customized matrix on a host computer, most methods load the customized matrix on the printer prior to producing copy-protected pages. This process is time consuming. Another disadvantage is that a customized dither matrix is not optimized to a printer's print engine like a printer's standard dither matrix. Therefore, shades of gray and/or color may vary between different printers using the customized matrix because it does not adequately account for each printer's print engine characteristics.

The “pixel-by-pixel” method of sending and printing patterns on a copy-protected page is also disadvantageous. One square inch of paper has 600 by 600 (i.e., 360,000) pixel spaces for a 600 dpi (dots per inch) printer. A single 8 inch line across a page is therefore only 1/600 of an inch high and has 4800 pixel spaces. Thus, 2,880,000 (i.e., 4800 by 600) potential pixels could be printed on one inch of paper 8 inches across. To print in a gray color space having 256 shades of gray, each pixel requires 1 byte of data sent to the printer. It is therefore clear that an immense amount of data is required to print patterns using a “pixel-by-pixel” method. The amount of data to print pixels in an RGB (red, green, blue) or CMYK (cyan, magenta, yellow, black) color space is significantly more, as each pixel represents 3 and 4 bytes of data respectively. Thus, the “pixel-by-pixel” method of producing copy-protected pages is very time-intensive.

Accordingly, the need exists for a way to print copy-protected documents that avoids the time and expense involved with prior methods.

### SUMMARY

Copy-protected documents are printed by merging a copy-protection template with a print job. When the print job is printed, it includes one or more substantially hidden security related objects mingled within a light background pattern. Neither the security objects nor the background pattern are conspicuous to a casual observer of the printed document. However, when the document is photocopied, the security objects become conspicuous, making the original document easily distinguishable from its copied version by virtue of the security objects.

A copy-protection template includes objects that are filled with pixel patterns. The pixel patterns are created using a user-defined pattern command of a page description language (PDL). A first object is filled with a first pixel pattern that serves as a background pattern in a copy-protected document. One or more additional objects are filled with a second pixel pattern. The additional objects represent various text, logos, or numbers that provide a type of security warning that is substantially hidden on the original copy-protected document. The security warning is hidden by virtue of how the second pixel pattern is interspersed within the first pixel pattern.

In one embodiment, a copy-protection template is stored on a host computer, along with the objects and patterns used to fill in the template. In another embodiment, one or more selectable copy-protection templates are stored on a host computer, along with the objects and patterns used to fill in the templates. With respect to both of these embodiments, a print job sent from the host computer to a printer includes a copy-protection instruction. A template, objects, and patterns are also sent from the host computer to the printer. Based on the copy-protection instruction, the printer formats the template with the objects and their patterns and merges the template with the print job.

### BRIEF DESCRIPTION OF THE DRAWINGS

The same reference numbers are used throughout the drawings to reference like components and features.

FIG. 1 illustrates an example of a prior art dither matrix having 16 gray scale values.

FIG. 2 illustrates the dither matrix of FIG. 1 with pixels printed for both 60% and 20% gray scale intensities.

FIG. 3 illustrates a system environment that is suitable for printing copy-protected documents.

FIG. 4 is a block diagram illustrating in greater detail, an exemplary embodiment of a host computer and printing device such as those shown in FIG. 3.

FIG. 5 is a block diagram illustrating in greater detail, an additional exemplary embodiment of a host computer and printing device such as those shown in FIG. 3.

FIG. 6 illustrates an example of an original copy-protected document.

FIG. 7 illustrates an example of a pixel pattern within a region of a background object of an original copy-protected document such as that shown in FIG. 6.

FIG. 8 illustrates an example of a pixel pattern within a region of a foreground object of an original copy-protected document such as that shown in FIG. 6.

FIG. 9 illustrates the combined pixel patterns of FIGS. 7 and 8 as they might be printed on an original copy-protected document such as that shown in FIG. 6.

FIG. 10 illustrates an example of a photocopied version of an original copy-protected document such as that shown in FIG. 6.

FIG. 11 is a flow diagram illustrating an example method of printing a copy-protected document.

FIG. 12 is a flow diagram illustrating an additional example method of printing a copy-protected document.

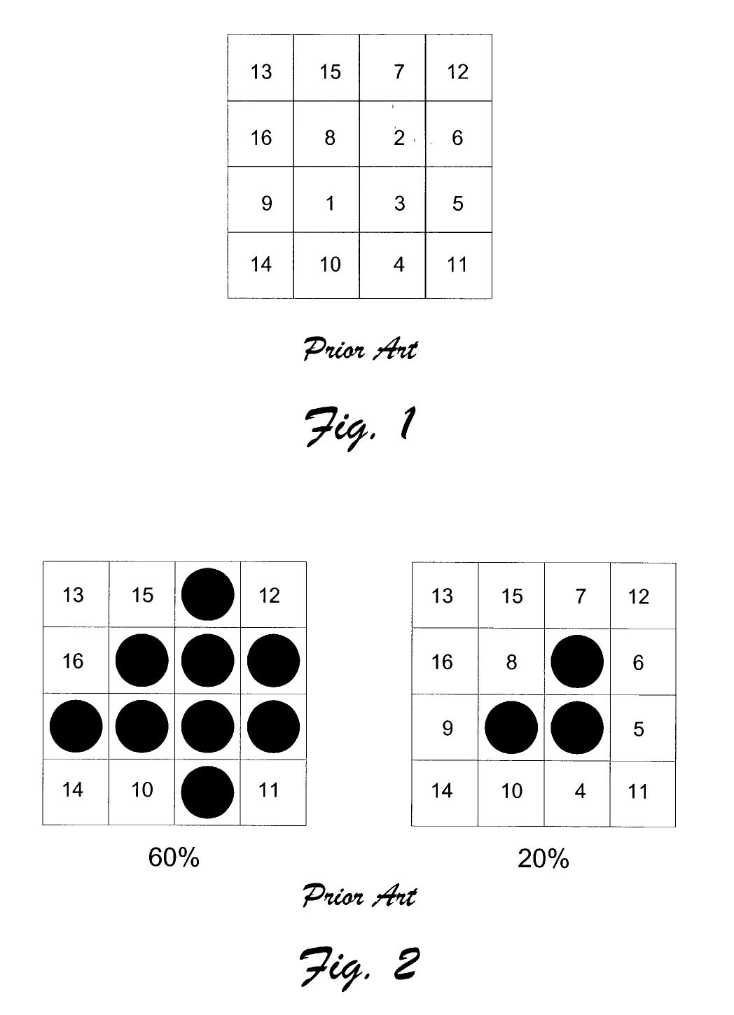

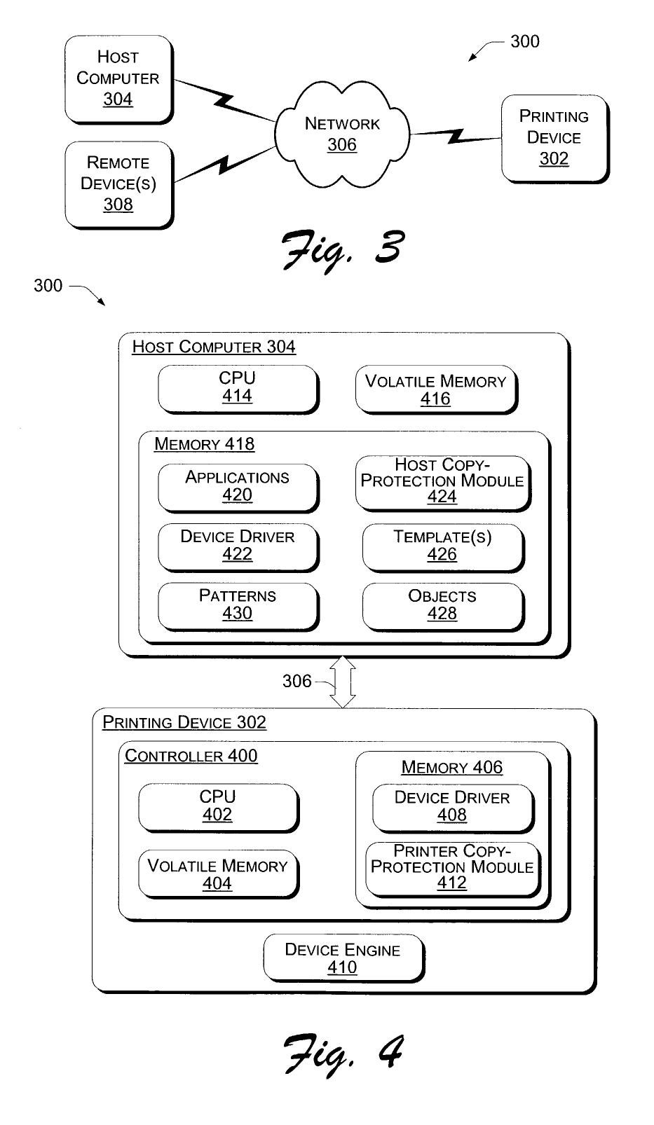

### DETAILED DESCRIPTION

The system and methods described herein relate to printing photocopy-protected documents. Rather than requiring pre-prepared, copy-protected media for printing a copy-protected document, a copy-protection template includes background and foreground patterns that create substantially hidden copy-protection symbols on an originally printed document. A photocopy of the original document reveals the copy-protection symbols that were not noticeable in the original document. Thus, print jobs are copy-protected when they are printed on a page along with the copy-protection template.

Exemplary System for Printing Photocopy-Protected Documents

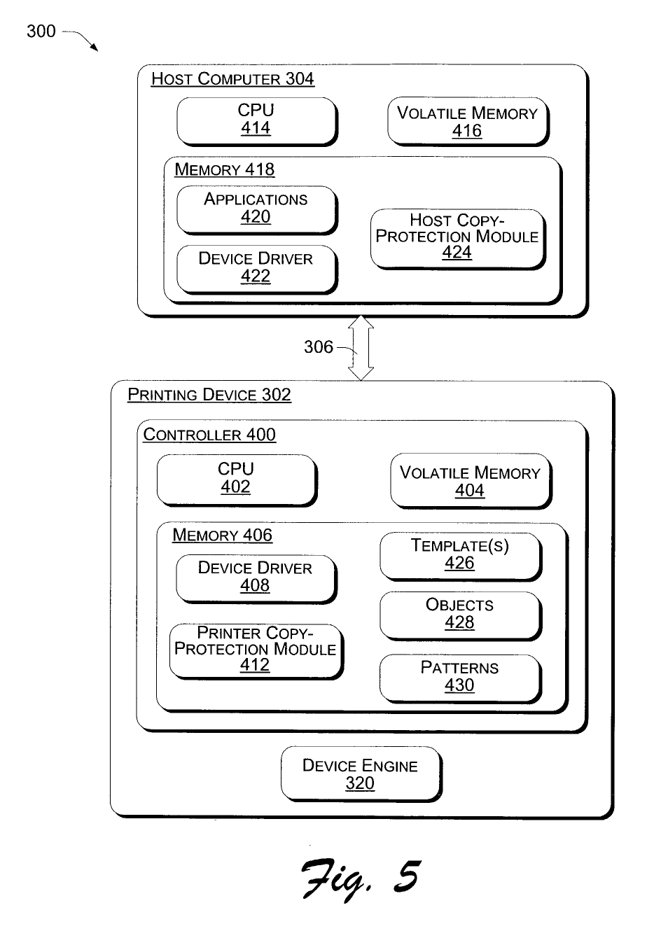

FIG. 3 illustrates a system environment that is suitable for printing copy-protected documents. The system 300 of FIG. 3 includes printing device 302 operatively coupled to a host computer 304 through a direct or network connection 306. The system 300 may also include additional remote device(s) 308 coupled to printing device 302 and/or host computer 304 through network 306. The direct or network connection 306 can include, for example, a printer cable, a LAN (local area networks), a WAN (wide area networks), an intranet, the Internet, or any other suitable communication link. This disclosure is applicable to various types of printing devices capable of rendering PDL (page description language) data in printed form on a print medium, such as printing pixels on paper. Therefore, printing device 302 can include devices such as laser-based printers, ink-based printers, plotters, multifunction peripheral devices and the like.

Host computer 304 and remote device(s) 308 can generally be implemented as a variety of general purpose computing devices including, for example, a personal computer (PC), a server, a Web server, and other devices configured to communicate with printing device 302. Host computer 304 typically provides a user with the ability to manipulate or otherwise prepare in electronic form, an image or document to be rendered as an image that is printed or otherwise formed onto a print medium by printing device 302 after transmission over network 306. In general, host computer 304 outputs host data to printing device 302 in a driver format suitable for the device 302, such as PCL or PostScript. Printing device 302 converts the host data and outputs it onto an appropriate recording media, such as paper or transparencies.

Exemplary Embodiment of a System for Printing Photocopy-Protected Documents

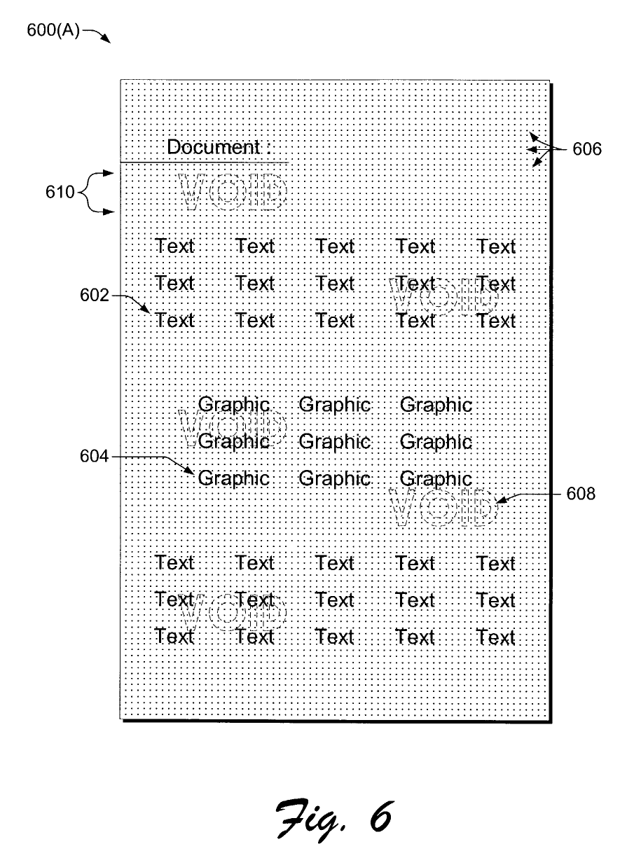

FIG. 4 illustrates an exemplary embodiment of the system 300 in more detail. The printing device 302 has a controller 400 that processes data from host computer 304. The controller 400 typically includes a data processing unit or CPU 402, a volatile memory 404 (i.e., RAM), and a nonvolatile memory 406. Nonvolatile memory 406 can include various computer storage media such as ROM, flash memory, a hard disk, a removable floppy disk, a removable optical disk and the like. Nonvolatile memory 406 generally provides storage of computer readable instructions, data structures, program modules and other data for printing device 302. Printing device driver module 408 executes on processor 402 to format host data into page description language (PDL) such as PostScript or Printer Control Language (PCL) or another appropriate format to control the output of printing device 302 through printer device engine 410. Device driver 408 might also be implemented on host computer 304.

In the exemplary embodiment of FIG. 4, printing device 302 also has a printer copy-protection module 412 that operates in conjunction with device driver 408 to produce copy-protected documents. Copy-protection module 412 is configured to interpret copy-protection instructions and copy-protection data received from host computer 304. The copy-protection data includes a copy-protection template, objects and pixel patterns as discussed below. The copy-protection instructions and data are typically received from host computer 304 along with a print job. However, the copy-protection data might also be located on a remote device 308. Thus, the copy-protection instruction may be received from host computer 304, while a copy-protection template, objects and pixel patterns are received from remote device 308 as directed by the copy-protection instruction. Copy-protection module 412 is configured to format the copy-protection template with the objects and pixel patterns based on the received instructions, and to merge the copy-protection template with the print job to produce a copy-protected document. The copy-protection template and copy-protected document are discussed more thoroughly below.

Host computer 304 includes a processor 414, a volatile memory 416 (i.e., RAM), and a non-volatile memory 418 (e.g., ROM, hard disk, floppy disk, CD-ROM, etc.). Nonvolatile memory 418 generally provides storage of computer readable instructions, data structures, program modules and other data for host computer 304. Host computer 304 may implement various application programs 420 stored in memory 418 and executed on processor 414 that create a document or image (e.g., text and graphics) on a computer screen that is transferred to printing device 302 for creating a hard copy of the document/image. Such applications 420 might include software programs implementing word processors, illustrators, computer-aided design tools and the like. Host computer 304 may also implement one or more software-based device drivers 422 stored in non-volatile memory 418 and executed on processor 414 to format document data into page description language (PDL) such as PostScript or printer control language (PCL) or another appropriate format which it outputs to printing device 302. Such device drivers 422 can also be implemented on the specific device they are “driving”, such as discussed above with respect to device driver 408 on printing device 302.

In the exemplary embodiment of FIG. 4, host computer 304 also includes a host copy-protection module 424, a template(s) module 426, an objects module 428 and a pixel pattern module 430 stored in memory 418. The host copy-protection module 424 is configured to provide a user with a copy-protection option upon printing a document from within the various application programs 420. Thus, when a user prints a document from within a word processing application 420 for example, the copy-protection module 424 presents a selectable option that permits the user to print the document as a copy-protected document (e.g., document 600 of FIG. 6).

In one instance of the exemplary embodiment of FIG. 4, when the copy-protection option is selected, the host copy-protection module 424 retrieves a predetermined copy-protection template 426 along with predetermined objects 428 and pixel patterns 430 from memory 418. A copy-protection template 426 generally provides a layout that indicates where objects 428 and patterns 430 are to be placed on a copy-protected document. The host copy-protection module 424 sends the template 426, the objects 428, and the pixel patterns 430 to printing device 302 along with a copy-protection instruction that informs the printer's copy-protection module 412 to format the template 426 with the objects 428 and pixel patterns 430 as described below with respect to FIGS. 6-9. A print job is also sent to printing device 302 which the printer copy-protection module 412 merges with the formatted template 426 to produce a copy-protected document.

Alternatively, the host copy-protection module 424 may format the copy-protection template 426 with the objects 428 and pixel patterns 430 at the host computer 304. Then the host copy-protection module 424 may either merge the formatted template 426 with the print job and send the merged print job to printing device 302, or, the host copy-protection module 424 may send the formatted template 426 and the print job to the printing device 302 to be merged by the printer's copy-protection module 412.

In another instance of the exemplary embodiment of FIG. 4, when the copy-protection option is selected, the host copy-protection module 424 presents further options permitting the user to select one of a number of copy-protection templates 426. Each of the selectable templates 426 may have predefined objects 428 with which the template will be formatted, or, the user may have additional options which permit the selection of specific objects 428 with which a selected template 426 will be formatted. Thus, the host copy-protection module 424 permits a user to design, to some extent, the copy-protection template 426 that will be printed with the print job being sent to printing device 302. In general, the pixel patterns 430 used to fill in the selected objects 428 are predefined. However, the pixel patterns 430 could also be selectable by a user.

Once the copy-protection template 426, the objects 428, and the pixel patterns 430 are defined and/or selected by a user, the host copy-protection module 424 may transfer them to the printing device 302 to be formatted and merged with a print job by the printer's copy-protection module 412. As discussed above, the host copy-protection module 424 may, alternatively, format the template 426 with the objects 428 and pixel patterns 430 at the host computer 304. Then the host copy-protection module 424 may either merge the formatted template 426 with a print job and send the merged print job to printing device 302, or, the host copy-protection module 424 may send the formatted template 426 and the print job to the printing device 302 to be merged by the printer's copy-protection module 412.

Additional Exemplary Embodiment of a System for Printing Photocopy-Protected Documents

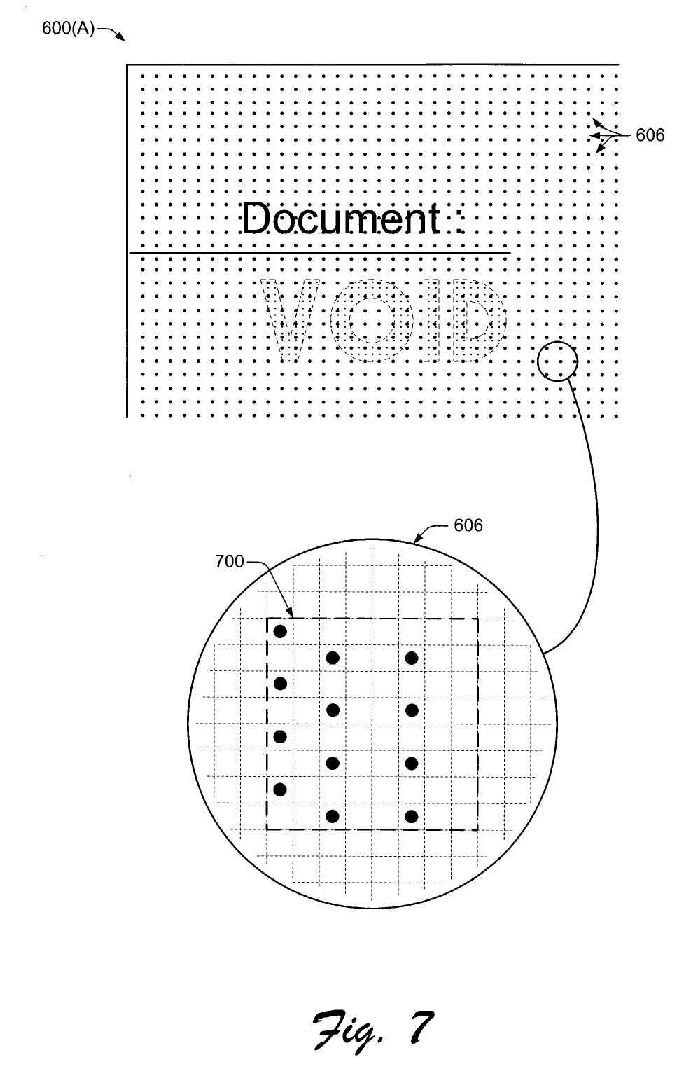

FIG. 5 illustrates an additional exemplary embodiment of system 300 of FIG. 3 in more detail. The printing device 302 and host computer 304 are configured substantially the same as they are in the prior embodiment of FIG. 4, except that the template(s) module 426, the objects module 428, and the pixel pattern module 430 are stored in memory 406 on printing device 302 rather than in memory 418 on host computer 304.

The basic functionality of the FIG. 5 embodiment is the same as that described above for the FIG. 4 embodiment. Thus, the host copy-protection module 424 is configured to provide a user with a copy-protection option upon printing a document from within the various application programs 420. In a first instance of the exemplary embodiment of FIG. 5, when the copy-protection option is selected, the host copy-protection module 424 sends a print job and a copy-protection instruction to the printing device 302 indicating that the print job should be printed with a copy-protection template 426. The printer copy-protection module 412 interprets the instruction and retrieves a predetermined copy-protection template 426 along with predetermined objects 428 and pixel patterns 430 from memory 406. The printer copy-protection module 412 formats the template 426 with the objects 428 and pixel patterns 430 as described below with respect to FIGS. 6-9, and merges/integrates the formatted template 426 with the print job to produce a copy-protected document (e.g., document 600 of FIG. 6).

In another instance of the exemplary embodiment of FIG. 5, when the copy-protection option is selected, the host copy-protection module 424 presents further options permitting the user to select one of a number of copy-protection templates 426. As described above with respect to the embodiment of FIG. 4, each of the selectable templates 426 may have predefined objects 428 with which the template will be formatted, or, the user may have additional options which permit the selection of specific objects 428 with which a selected template 426 will be formatted. Thus, the host copy-protection module 424 permits a user to design, to some extent, the copy-protection template 426 that will be printed with a print job being sent to printing device 302. The pixel patterns 430 used to fill in the selected objects 428 are typically predefined. However, the pixel patterns 430 could also be selectable by a user.

Once the copy-protection template 426, the objects 428, and the pixel patterns 430 are defined and/or selected by a user, the host copy-protection module 424 sends the print job and a copy-protection instruction to the printing device 302. The copy-protection instruction in this instance not only indicates that the print job should be printed with a copy-protection template 426, but it also informs the printer copy-protection module 412 which copy-protection template 426, objects 428, and pixel patterns 430 are to be used, as defined and/or selected by the user. The printer copy-protection module 412 interprets the instruction and retrieves the appropriate copy-protection template 426, objects 428 and pixel patterns 430 from memory 406. The printer copy-protection module 412 formats the template 426 with the objects 428 and pixel patterns 430 as described below with respect to FIGS. 6-9, and integrates or merges the configured template 426 with the print job to produce a copy-protected document.

Exemplary Photocopy-Protected Document

FIG. 6 illustrates an example of an original copy-protected document 600(A) as it might appear after printing from a printing device 302. The document 600(A) includes typical text 602 and graphics 604 that are typically part of a print job created by an application program 420 on a host computer 304. The document 600(A) also includes a formatted copy-protection template 426 that contains copy-protection features in the form of a background pixel pattern 606 and a foreground pixel pattern 608. The background pixel pattern 606 fills a first or background object that essentially outlines an area larger than the object to be obscured. The foreground pixel pattern 608 fills a second or foreground object 610 that forms a security warning of some type. The security-related object 610 is typically text that spells out a word such as “VOID” or “COPY”, or it may also be a company logo or any other object that serves as an identifier. Therefore, the copy-protected document 600(A) is generally made up of a print job that includes typical printed items such as text 602 and graphics 604 and a formatted copy-protection template 426 that contains copy-protection features in the form of a background pixel pattern 606 and a foreground pixel pattern 608.

The copy-protected document 600(A) of FIG. 6 is an example only, and is intended to illustrate that the background pattern 606 is a light background that is barely noticeable to a casual observer viewing the document 600(A). In addition, copy-protected document 600(A) is intended to illustrate that the foreground pattern 608 that fills security-related object 610 (i.e., “VOID”) is also barely noticeable to a casual observer viewing the document 600(A). Moreover, copy-protected document 600(A) is intended to illustrate that the foreground pattern 608 that fills object 610 is hidden within, or subdued by, the background pattern 606.

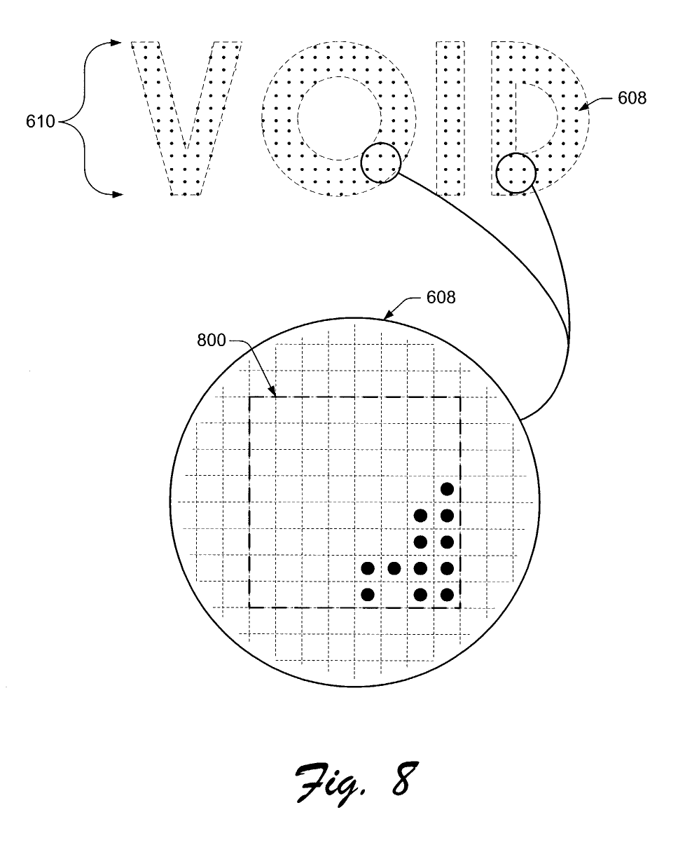

FIGS. 7, 8 and 9 help to clarify how the host and printer copy-protection modules (424 and 412) format or configure a copy-protection template 426 with objects 428 and pixel patterns 430. Pixel patterns 430 are user-defined patterns that are typically created by a copy-protection solution developer and stored in the memory of the host computer 304 or printing device 302. Most printing devices employ the use of a page description language (PDL) such as PostScript or PCL (printer control language) that includes a “user-defined pattern command”. Type, images and other objects can be filled with user-defined patterns that are downloadable to a printer using the user-defined pattern command. Once downloaded, the patterns can be used to fill type, images and other objects. Typically, use of a user-defined pattern involves assigning an ID number to the pattern, setting a pattern reference point to a desired position within a region, specifying the pattern as permanent or temporary, and downloading the pattern to the printing device.

FIG. 7 illustrates an example of a first user-defined pixel pattern 430. The first pattern 700 is repeated within an object area to form the background pixel pattern 606 of copy-protected document 600(A). The first pattern 700 is one example of a pixel pattern 430 as discussed above with reference to the exemplary embodiments of system 300. The first pattern 700 is a symmetrical pattern in that pixels are dispersed in a predictable manner within a given region. For example, a pixel is printed in the first location on every other line of the first pattern 700. On the alternate lines within the first pattern 700, pixels are printed in the third and sixth locations. Thus, the first pattern 700 is predictable and symmetrical.

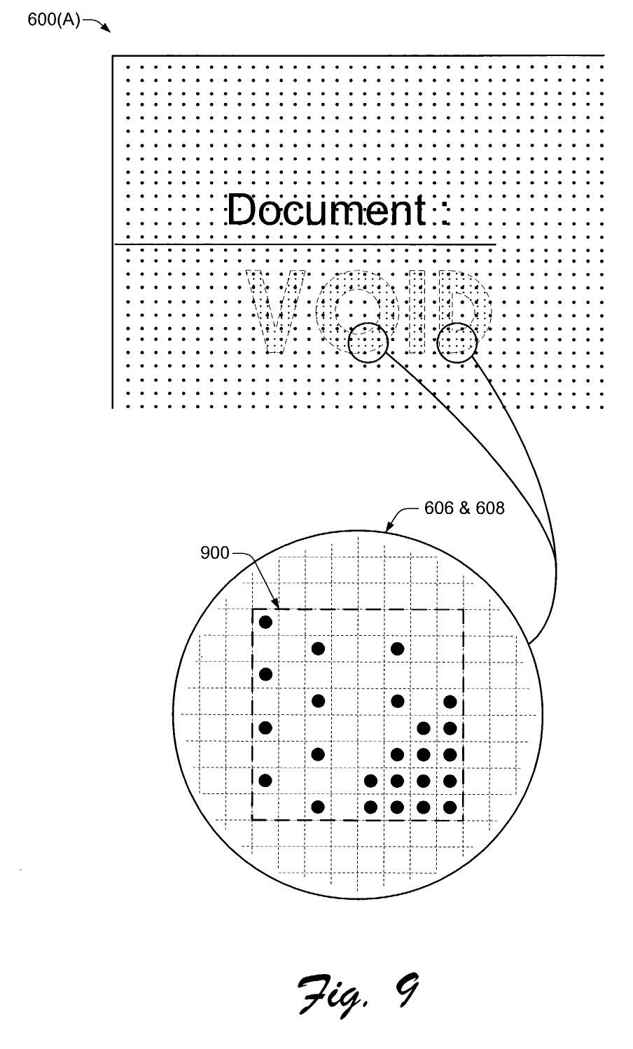

FIG. 8 illustrates an example of a second user-defined pixel pattern 430. The second pattern 800 is repeated within the area of object 610 to form the foreground pixel pattern 608 of copy-protected document 600(A). The second pattern 800 is another example of a pixel pattern 430 as discussed above with reference to the exemplary embodiments of system 300. The second pattern 800 is an asymmetrical pattern in that pixels are dispersed in an unpredictable manner within a given region. For example, all the pixels are printed toward the lower right hand corner of the region in the second pattern 800. Thus, within the pattern itself, the second pattern 800 is unpredictable and asymmetrical.

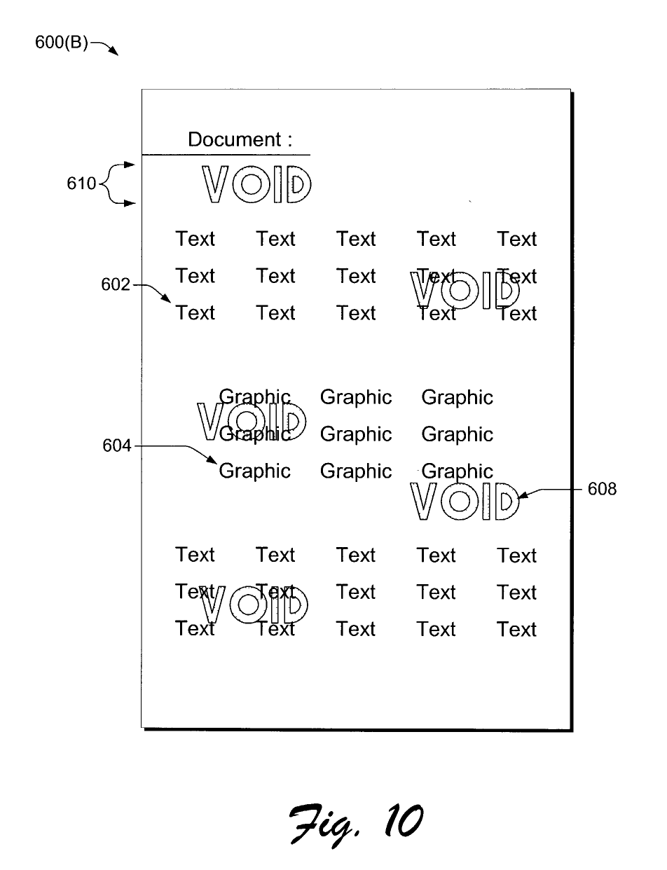

FIG. 9 illustrates a combined pixel pattern 900 formed by the combination of the first and second pixel patterns, 700 and 800, as they might be printed on the original copy-protected document 600(A) of FIG. 6. Referring to FIGS. 7 and 8, it is noted that the first and second pixel patterns, 700 and 800, both have a statistically equivalent number of pixels within the given region. Furthermore, when the first and second pixel patterns are printed together on copy-protected document 600(A), thus forming the combined pixel pattern 900, they do not intersect each other. That is, within the given region, the pixels of the first pixel pattern 700 do not fall into any of the locations to be occupied by the second pixel pattern 800.

This arrangement or formatting of the second pixel pattern 800 within the first pixel pattern 700 serves an important purpose in the original copy-protected document 600(A) as well as when a photocopy is made of the copy-protected document 600(A). In the original copy-protected document 600(A), the arrangement of first and second pixel patterns, 700 and 800, creates the background pixel pattern 606 and the foreground pixel pattern 608 such that the security-related object 610 (i.e., “VOID”) is inconspicuous to a casual observer viewing copy-protected document 600(A). The foreground pixel pattern 608, which is made up of second pixel pattern 800 filling in the security-related object 610, is subdued by the background pixel pattern 606, which is made up of first pixel pattern 700. When a photocopy is made of the copy-protected document 600(A), the pixel arrangement causes the background pixel pattern 606 to fall out and not be picked up on the photocopy. However, the area bounded by the security-related object 610 which contains a combination of the first pixel pattern 700 and second pixel pattern 800 becomes prominent in the photocopied version of the copy-protected document 600(A).

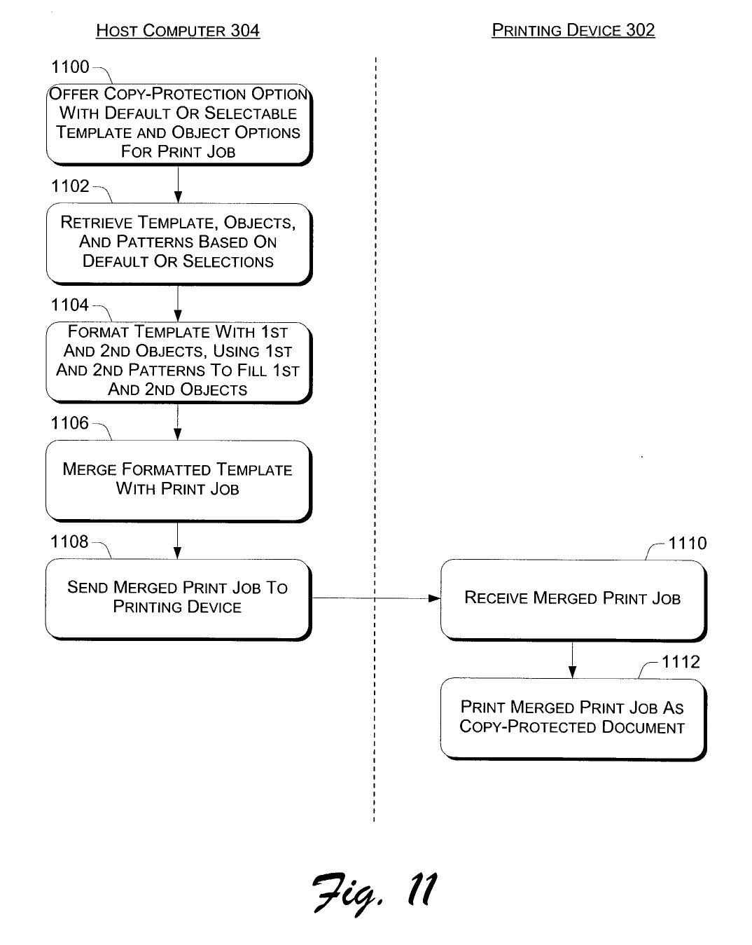

FIG. 10 illustrates an example of a photocopied version 600(B) of the original copy-protected document 600(A) of FIG. 6. The photocopy 600(B) shows how a photocopy machine will substantially fail to pick up the background pixel pattern 606, while picking up and making prominent the security-related object 610 (i.e., “VOID”). Thus, the casual observer of the photocopy 600(B) notices with ease that the photocopy 600(B) is not an original document.

Exemplary Methods for Printing Photocopy-Protected Documents

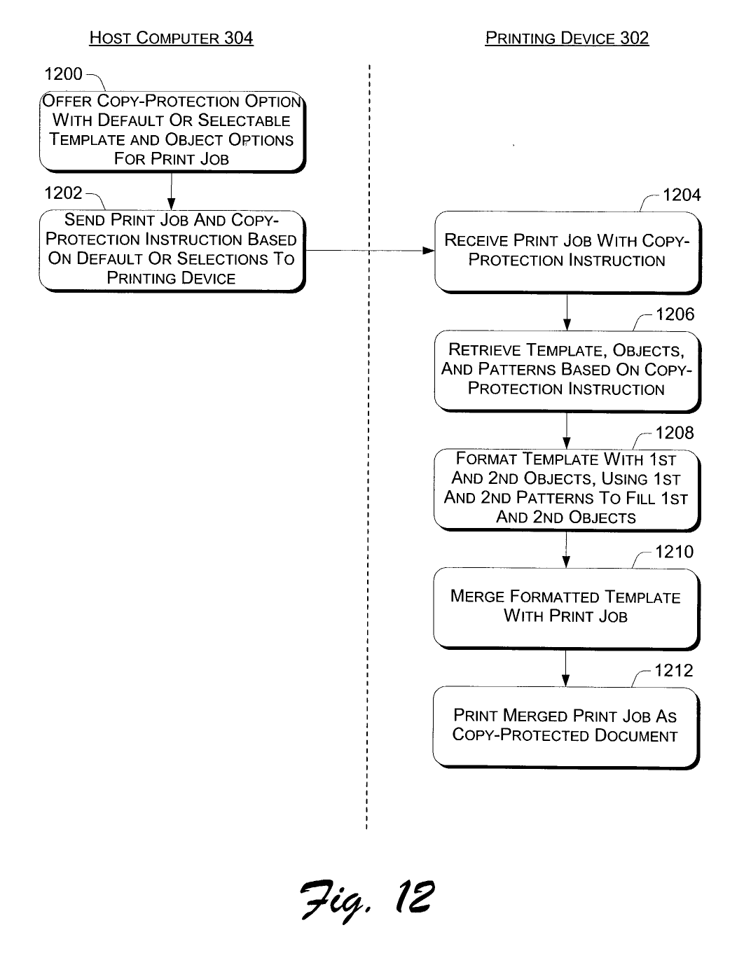

Example methods for printing photocopy-protected documents will now be described with primary reference to FIGS. 11 and 12. The methods apply generally to the exemplary embodiments of system 300 discussed above with reference to FIGS. 4 and 5.

FIGS. 11 and 12 are flow diagrams that show examples of general methods for printing photocopy-protected documents. At block 1100 of FIG. 11, the host computer 304 offers an option for printing a print job with copy-protection. The copy-protection option can be offered to a user while printing a document from within any suitable application program 420. If selected, the copy-protection option may provide a default copy-protection template, objects, and pixel patterns to be used in the copy-protected document. However, the copy-protection option may provide further options to select from various copy-protection templates, objects, and pixel patterns to be used in the copy-protected document.

At block 1102, the host computer 304 retrieves the copy-protection templates, objects, and pixel patterns that have been defined in block 1100 through default or user selection. At block 1104, the host computer 304 formats the copy-protection template with first and second objects, with a first pixel pattern being used to fill in a first object and a second pixel pattern being used to fill in a second object. At block 1106, the host computer 304 merges the formatted copy-protection template with the print job. The merged print job is then sent to printing device 302 at block 1108.

At block 1110, printing device 302 receives the merged print job from host computer 304. Printing device 302 then prints the merged print job as a copy-protected document at block 1112.

FIG. 12 is a flow diagram illustrating an additional example method of printing a copy-protected document. At block 1200 of FIG. 12, the host computer 304 offers an option for printing a print job with copy-protection. As with the previous method, the copy-protection option can be offered to a user while printing a document from within any suitable application program 420. If selected, the copy-protection option may provide a default copy-protection template, objects, and pixel patterns to be used in the copy-protected document, or, the copy-protection option may provide further options to select from various copy-protection templates, objects, and pixel patterns to be used in the copy-protected document.

At block 1202, the host computer 304 sends the print job and a copy-protection instruction to the printing device 302. The copy-protection instruction includes information regarding copy-protection templates, objects, and pixel patterns that have been defined in block 1200.

At block 1204, the printing device 302 receives the print job and the copy-protection instruction from the host computer 304. At block 1206, the printing device 302 retrieves the appropriate copy-protection template, objects, and pixel patterns based on information in the copy-protection instruction. At block 1208, the printing device 302 formats the copy-protection template with first and second objects, with a first pixel pattern being used to fill in a first object and a second pixel pattern being used to fill in a second object. At block 1210, the printing device 302 merges the formatted copy-protection template with the print job. At block 1212, printing device 302 then prints the merged print job as a copy-protected document.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method of printing a copy-protected document comprising:
receiving a print job that includes a copy-protection instruction;
based on the instruction, merging the print job with a copy-protection template; and
printing the print job.

2. A method as recited in claim 1, wherein the merging further comprises:
retrieving the copy-protection template;
retrieving a first pattern and a second pattern;
retrieving a first object and a second object;
formatting the copy-protection template with the first object and the second object, the first object comprising the first pattern and the second object comprising the second pattern; and
integrating the copy-protection template with the print job.

3. A method as recited in claim 1, further comprising:
receiving along with the print job, a first pattern, a second pattern, a first object, a second object, and the copy-protection template;
formatting the copy-protection template with the first object and the second object, the first object comprising the first pattern and the second object comprising the second pattern; and
integrating the copy-protection template with the print job.

4. A method of printing a copy-protected document comprising:
receiving a print job that includes a copy-protection instruction;
based on the copy-protection instruction, printing a first pattern within an area bounded by a first object; and
based on the copy-protection instruction, printing a second pattern within an area bounded by a second object.

5. A method as recited in claim 4, further comprising printing the print job.

6. A method as recited in claim 4, further comprising retrieving the first pattern, the first object, the second pattern, and the second object from a memory.

7. A method as recited in claim 4, further comprising receiving the first pattern, the first object, the second pattern, and the second object along with the print job.

8. A method as recited in claim 4, wherein the printing the first pattern within the area bounded by the first object comprises:
arranging pixels into a first arrangement within a region; and
repeatedly printing the region within the area bounded by the first object until the area bounded by the first object is filled.

9. A method as recited in claim 8, wherein pixels of the first arrangement are arranged symmetrically within the region.

10. A method as recited in claim 4, wherein the printing the second pattern within the area bounded by the second object comprises:
arranging pixels into a second arrangement within a region; and
repeatedly printing the region within the area bounded by the second object until the area bounded by the second object is filled.

11. A method as recited in claim 10, wherein pixels of the second arrangement are arranged asymmetrically within the region.

12. A method as recited in claim 4, wherein the area bounded by the second object is within the area bounded by the first object.

13. A method as recited in claim 4, wherein the first object is bounded by the second object.

14. A method as recited in claim 4, wherein pixels of the first pattern are interspersed among pixels of the second pattern.

15. A method as recited in claim 14, wherein the pixels of the first pattern and the pixels of the second pattern do not intersect.

16. A method of producing a copy-protected document comprising:
creating a first pattern;
creating a second pattern;
printing the first pattern within an area bounded by a first object; and
printing the second pattern within an area bounded by a second object.

17. A method as recited in claim 16, wherein the creating further comprises activating a user-defined pattern command of a page description language (PDL).

18. A method as recited in claim 17, wherein the page description language is a language selected from a group of languages comprising:
PostScript; and
Printer Control Language (PCL).

19. A method as recited in claim 16, wherein the creating the first pattern comprises arranging pixels into a first arrangement within a region.

20. A method as recited in claim 19, wherein the creating the second pattern comprises arranging pixels into a second arrangement within the region.

21. A method as recited in claim 19, wherein the first arrangement is a symmetrical arrangement of pixels.

22. A method as recited in claim 20, wherein the second arrangement is an asymmetrical arrangement of pixels.

23. A method as recited in claim 20, wherein pixels of the second arrangement are interspersed among pixels of the first arrangement within the region.

24. A method as recited in claim 20, wherein the pixels of the second arrangement and the pixels of the first arrangement do not intersect.

25. A method as recited in claim 20, wherein the first arrangement has the same number of pixels as the second arrangement.

26. A method of printing a copy-protected document comprising:
presenting a selectable copy-protection option that offers to print a print job as a copy-protected document;
based on a selected copy-protection option, presenting additional selectable options for copy-protection templates and objects to be used in the copy-protected document;
based on selected additional options, retrieving a copy-protection template, objects, and pixel patterns;
formatting the copy-protection template as a formatted template to include a first object filled with a first pixel pattern and a second object filled with a second pixel pattern;
merging the formatted template with the print job as a merged print job; and
sending the merged print job to a printing device to be printed as the copy protected document.

27. A computer comprising:
a first pattern stored in a memory;
a second pattern stored in the memory;
one or more selectable objects stored in the memory; and
a copy-protection module configured to format a print job with a selected first object containing the first pattern and a selected second object containing the second pattern.

28. A computer as recited in claim 27, further comprising an application module configured to produce the print job.

29. A computer comprising:
a copy-protection template stored in a memory;
a first pattern stored in the memory;
a second pattern stored in the memory; and
a copy-protection module configured to format the template with the first pattern and the second pattern and merge the template with a print job.

30. A computer as recited in claim 29, wherein the template further comprises:
a first object configured to receive the first pattern; and
a second object configured to receive the second pattern.

31. A computer comprising:
one or more selectable copy-protection templates;
at least two patterns; and
a copy-protection module configured to format a selected template with a first pattern and a second pattern and merge the template with a print job.

32. A computer as recited in claim 31, wherein each template further comprises at least two objects configured to receive two of the at least two patterns.

33. A printer comprising:
a first pattern stored in a memory;
a second pattern stored in the memory;
one or more selectable objects stored in the memory; and
a copy-protection module configured to receive a copy-protection instruction, and based on the instruction, format a print job with a selected first object containing the first pattern and a selected second object containing the second pattern.

34. A printer comprising:
a copy-protection template stored in a memory;
a first pattern stored in the memory;
a second pattern stored in the memory; and
a copy-protection module configured to receive a copy-protection instruction, and based on the instruction, format the template with the first pattern and the second pattern and merge the template with a print job.

35. A printer as recited in claim 34, wherein the template further comprises:
a first object configured to receive the first pattern; and
a second object configured to receive the second pattern.

36. A printer comprising:
one or more selectable copy-protection templates;
at least two patterns; and
a copy-protection module configured to receive a copy-protection instruction, and based on the instruction, format a selected template with a first pattern and a second pattern and merge the template with a print job.

37. A printer as recited in claim 36, wherein each of the one or more selectable copy-protection templates further comprises at least two objects configured to receive two of the at least two patterns.

38. A system comprising:
at least two copy-protection objects;
at least two pixel patterns; and
a copy-protection module executable to offer a copy-protection option, and based on a selected option, to merge a print job with a first object and a second object, the first object arranged with a first pixel pattern and the second object arranged with a second pixel pattern.

39. A system comprising:
a host computer;
a printing device;
a first copy-protection module on the host computer configured to offer a copy-protection option, and based on a selected copy-protection option, to offer additional selectable options for copy-protection templates, objects, and pixel patterns to be used in a copy-protected document; and
a second copy-protection module on the printing device configured to interpret a copy-protection instruction from the host computer, and based on the instruction, to print a copy-protected document having a first pixel pattern within a first object and a second pixel pattern within a second object.

40. A system as recited in claim 39, further comprising:
a remote device configured to include the copy-protection templates, objects, and pixel patterns;
wherein the printing device retrieves the copy-protection templates, objects, and pixel patterns from the remote device upon interpreting the copy-protection instruction from the host computer.
